(19) United States
(12) Patent Application Publication
(10) Pub. No.: US 2025/0247892 A1
(43) Pub. Date: Jul. 31, 2025

(54) METHOD, DEVICE AND COMPUTER STORAGE MEDIUM OF COMMUNICATION

(71) Applicant: NEC CORPORATION, Tokyo (JP)

(72) Inventors: Da WANG, Beijing (CN); Lin LIANG, Beijing (CN); Gang WANG, Beijing (CN)

(73) Assignee: NEC CORPORATION, Tokyo (JP)

(21) Appl. No.: 18/855,380

(22) PCT Filed: Apr. 18, 2022
(86) PCT No.: PCT/CN2022/087479

§ 371 Date: Oct. 9, 2024

(51) Int. Cl. H04W 74/0833; H04W 56/00

(52) U.S. Cl. CPC H04W 74/0833; H04W 56/0045

(57) ABSTRACT

Embodiments of the present disclosure relate to methods, devices and computer readable media for communication. A terminal device receives, from a first network device, a lower-layer signaling indicating a cell change or addition for a cell of a second network device and comprising a configuration for a CFRA procedure for the primary cell. The terminal device performs a RA procedure on the primary cell at least based on the configuration. In this way, a dynamic configuration of a CFRA resource may be achieved for L1/L2 based mobility.

### TECHNICAL FIELD

Embodiments of the present disclosure generally relate to the field of telecommunication, and in particular, to methods, devices and computer storage media of communication based on a lower-layer signaling.

### BACKGROUND

When user equipment (UE) moves from a coverage area of one cell to that of another cell, a change or addition or release of a serving cell may need to be performed. Currently, the change or addition or release of the serving cell is triggered by layer 3 (L3) measurements and is done by radio resource control (RRC) signaling triggered Reconfiguration with Synchronization for change of primary cell (PCell) and primary secondary cell (PSCell). All cases involve complete layer 2 (L2) and layer 1 (L1) resets, leading to longer latency, larger overhead and longer interruption time than beam switch mobility.

Some solutions to the above issue are proposed based on a lower-layer signaling such as layer 1 (L1) or layer 2 (L2) signaling. In one solution, a data transmission is performed with a change of a serving cell upon reception of the lower-layer signaling, which is also referred to as a L1/L2 based mobility. In this way, the latency, overhead and interruption time may be reduced. However, more details in a L1/L2 based mobility procedure need to be further developed.

### SUMMARY

In general, embodiments of the present disclosure provide methods, devices and computer storage media of communication based on a lower-layer signaling.

In a first aspect, there is provided a method of communication. The method comprises: receiving, at a terminal device and from a first network device, a lower-layer signaling indicating a cell change or addition for a primary cell of a second network device, the lower-layer signaling comprising a first configuration for a contention free random access procedure for the primary cell; and performing, at least based on the first configuration, a first random access procedure on the primary cell.

In a second aspect, there is provided a method of communication. The method comprises: receiving, at a terminal device and from a first network device, a lower-layer signaling indicating a cell change or addition for a cell of a second network device; and maintaining a data processing related procedure in a medium access control layer.

In a third aspect, there is provided a method of communication. The method comprises: determining, at a first network device, a first configuration for a contention free random access procedure for a primary cell of a second network device; and transmitting, to a terminal device, a lower-layer signaling indicating a cell change or addition for the primary cell and comprising the first configuration.

In a fourth aspect, there is provided a method of communication. The method comprises: transmitting, at a first network device and to a terminal device, a lower-layer signaling indicating a cell change or addition for a cell of a second network device; and maintaining a data processing related procedure in a medium access control layer.

In a fifth aspect, there is provided a terminal device. The terminal device comprises a processor configured to perform the method according to any of the first to second aspects of the present disclosure.

In a sixth aspect, there is provided a network device. The network device comprises a processor configured to perform the method according to any of the third to fourth aspects of the present disclosure.

In a seventh aspect, there is provided a computer readable medium having instructions stored thereon. The instructions, when executed on at least one processor, cause the at least one processor to perform the method according to any of the first to second aspects of the present disclosure.

In an eighth aspect, there is provided a computer readable medium having instructions stored thereon. The instructions, when executed on at least one processor, cause the at least one processor to perform the method according to any of the third to fourth aspects of the present disclosure.

Other features of the present disclosure will become easily comprehensible through the following description.

### BRIEF DESCRIPTION OF THE DRAWINGS

Through the more detailed description of some embodiments of the present disclosure in the accompanying drawings, the above and other objects, features and advantages of the present disclosure will become more apparent, wherein:

FIG. TA illustrates an example communication network in which some embodiments of the present disclosure can be implemented;

FIG. 1B illustrates a schematic diagram illustrating network protocol layer entities that may be established for a user plane (UP) protocol stack at devices according to some embodiments of the present disclosure;

FIG. 1C illustrates a schematic diagram illustrating network protocol layer entities that may be established for a control plane (CP) protocol stack at devices according to some embodiments of the present disclosure;

FIG. 1D illustrates a schematic diagram of a central unit (CU)/distributed unit (DU) architecture in which some embodiments of the present disclosure can be implemented;

FIG. 1E illustrates a schematic diagram illustrating a process of L1/L2 based mobility in which some embodiments of the present disclosure can be implemented;

FIG. 2 illustrates a schematic diagram illustrating a process of performing a random access (RA) procedure in L1/L2 based mobility according to embodiments of the present disclosure;

FIG. 3 illustrates a schematic diagram illustrating a process of performing a medium access control (MAC) reset procedure in L1/L2 based mobility according to embodiments of the present disclosure;

FIG. 4 illustrates an example method of communication implemented at a terminal device in accordance with some embodiments of the present disclosure;

FIG. 5 illustrates another example method of communication implemented at a terminal device in accordance with some embodiments of the present disclosure;

FIG. 6 illustrates an example method of communication implemented at a network device in accordance with some embodiments of the present disclosure;

FIG. 7 illustrates another example method of communication implemented at a network device in accordance with some embodiments of the present disclosure; and

FIG. 8 is a simplified block diagram of a device that is suitable for implementing embodiments of the present disclosure.

Throughout the drawings, the same or similar reference numerals represent the same or similar element.

### DETAILED DESCRIPTION

Principle of the present disclosure will now be described with reference to some embodiments. It is to be understood that these embodiments are described only for the purpose of illustration and help those skilled in the art to understand and implement the present disclosure, without suggesting any limitations as to the scope of the disclosure. The disclosure described herein can be implemented in various manners other than the ones described below.

In the following description and claims, unless defined otherwise, all technical and scientific terms used herein have the same meaning as commonly understood by one of ordinary skills in the art to which this disclosure belongs.

As used herein, the term ‘terminal device’ refers to any device having wireless or wired communication capabilities. Examples of the terminal device include, but not limited to, user equipment (UE), personal computers, desktops, mobile phones, cellular phones, smart phones, personal digital assistants (PDAs), portable computers, tablets, wearable devices, internet of things (IoT) devices, Ultra-reliable and Low Latency Communications (URLLC) devices, Internet of Everything (IoE) devices, machine type communication (MTC) devices, device on vehicle for V2X communication where X means pedestrian, vehicle, or infrastructure/network, devices for Integrated Access and Backhaul (IAB), Space bome vehicles or Air bome vehicles in Non-terrestrial networks (NTN) including Satellites and High Altitude Platforms (HAPs) encompassing Unmanned Aircraft Systems (UAS), eXtended Reality (XR) devices including different types of realities such as Augmented Reality (AR), Mixed Reality (MR) and Virtual Reality (VR), the unmanned aerial vehicle (UAV) commonly known as a drone which is an aircraft without any human pilot, devices on high speed train (HST), or image capture devices such as digital cameras, sensors, gaming devices, music storage and playback appliances, or Internet appliances enabling wireless or wired Internet access and browsing and the like. The ‘terminal device’ can further has ‘multicast/broadcast’ feature, to support public safety and mission critical, V2X applications, transparent IPv4/IPv6 multicast delivery, IPTV, smart TV, radio services, software delivery over wireless, group communications and IoT applications. It may also incorporated one or multiple Subscriber Identity Module (SIM) as known as Multi-SIM. The term “terminal device” can be used interchangeably with a UE, a mobile station, a subscriber station, a mobile terminal, a user terminal or a wireless device.

The term “network device” refers to a device which is capable of providing or hosting a cell or coverage where terminal devices can communicate. Examples of a network device include, but not limited to, a Node B (NodeB or NB), an evolved NodeB (eNodeB or eNB), a next generation NodeB (gNB), a transmission reception point (TRP), a remote radio unit (RRU), a radio head (RH), a remote radio head (RRH), an IAB node, a low power node such as a femto node, a pico node, a reconfigurable intelligent surface (RIS), and the like.

The terminal device or the network device may have Artificial intelligence (AI) or Machine learning capability. It generally includes a model which has been trained from numerous collected data for a specific function, and can be used to predict some information.

The terminal or the network device may work on several frequency ranges, e.g. FR1 (410 MHz to 7125 MHz), FR2 (24.25 GHz to 71 GHz), frequency band larger than 100 GHz as well as Tera Hertz (THz). It can further work on licensed/unlicensed/shared spectrum. The terminal device may have more than one connections with the network devices under Multi-Radio Dual Connectivity (MR-DC) application scenario. The terminal device or the network device can work on full duplex, flexible duplex and cross division duplex modes.

The embodiments of the present disclosure may be performed in test equipment, e.g. signal generator, signal analyzer, spectrum analyzer, network analyzer, test terminal device, test network device, channel emulator.

In one embodiment, the terminal device may be connected with a first network device and a second network device. One of the first network device and the second network device may be a master node and the other one may be a secondary node. The first network device and the second network device may use different radio access technologies (RATs). In one embodiment, the first network device may be a first RAT device and the second network device may be a second RAT device. In one embodiment, the first RAT device is eNB and the second RAT device is gNB. Information related with different RATs may be transmitted to the terminal device from at least one of the first network device or the second network device. In one embodiment, first information may be transmitted to the terminal device from the first network device and second information may be transmitted to the terminal device from the second network device directly or via the first network device. In one embodiment, information related with configuration for the terminal device configured by the second network device may be transmitted from the second network device via the first network device. Information related with reconfiguration for the terminal device configured by the second network device may be transmitted to the terminal device from the second network device directly or via the first network device.

As used herein, the singular forms ‘a’, ‘an’ and ‘the’ are intended to include the plural forms as well, unless the context clearly indicates otherwise. The term ‘includes’ and its variants are to be read as open terms that mean ‘includes, but is not limited to.’ The term ‘based on’ is to be read as ‘at least in part based on.’ The term ‘one embodiment’ and ‘an embodiment’ are to be read as ‘at least one embodiment.’ The term ‘another embodiment’ is to be read as ‘at least one other embodiment.’ The terms ‘first,’ ‘second,’ and the like may refer to different or same objects. Other definitions, explicit and implicit, may be included below.

In some examples, values, procedures, or apparatus are referred to as ‘best,’ ‘lowest,’‘highest,’ ‘minimum,’ ‘maximum,’ or the like. It will be appreciated that such descriptions are intended to indicate that a selection among many used functional alternatives can be made, and such selections need not be better, smaller, higher, or otherwise preferable to other selections.

In the context of the present disclosure, the term “a cell change or addition” may be interchangeably used with “reconfiguration with sync for secondary cell group (SCG) or master cell group (MCG)”. The term “PSCell” refers to a SpCell of a SCG, the term “PCell” refers to a SpCell of a MCG, and the term “SpCell” refers to a primary cell of a SCG or MCG. The term “SCell” refers to a secondary cell. The term “L1/L2 based mobility” may be interchangeably used with “L1/L2 based mobility procedure” or “a cell change or addition based on a lower-layer signaling” or “L1/L2 based handover”. The term “lower-layer signaling” may be interchangeably used with “L1/L2 signaling”. The term “RRC reconfiguration” may be interchangeably used with “RRC reconfiguration message”. The term “data transmission” refers to the transmitting and receiving of data.

Currently, it is proposed to specify mechanisms and procedures of L1/L2 based mobility for mobility latency reduction for the following aspects:
configuration and maintenance for multiple candidate cells to allow fast application of configurations for candidate cells;
dynamic switch mechanism among candidate serving cells (including SpCell and SCell) for the potential applicable scenarios based on L1/L2 signaling;
L1 enhancements for inter-cell beam management, including L1 measurement and reporting, and beam indication;
timing advance (TA) management;
CU-DU interface signaling to support L1/L2 mobility, if needed.

The procedure of L1/L2 based mobility may be applicable to the following scenarios:
standalone, carrier aggregation (CA) and new radio (NR)-dual connectivity (DC) case with serving cell change within one cell group (CG);
intra-DU case and intra-CU inter-DU case (applicable for Standalone and CA: no new RAN interfaces are expected);
both intra-frequency and inter-frequency;
both frequency range 1 (FR1) and frequency range 2 (FR2);
source and target cells may be synchronized or non-synchronized.

Embodiments of the present disclosure provide improved solutions of communication for L1/L2 based mobility so as to achieve mobility latency reduction and other potential advantages.

In one aspect, a configuration for a contention free random access (CFRA) procedure for a target cell is comprised in a L1/L2 signaling. In this way, a dynamic configuration of a CFRA resource can be achieved for L1/L2 based mobility.

In another aspect, a data processing related procedure in a MAC layer is maintained for a L1/L2 based mobility. In this way, data transmission may be not interrupted, and service interruption may be reduced.

Principles and implementations of the present disclosure will be described in detail below with reference to the figures.

### Example of Communication Network

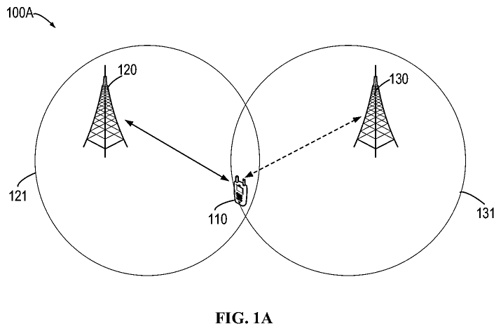

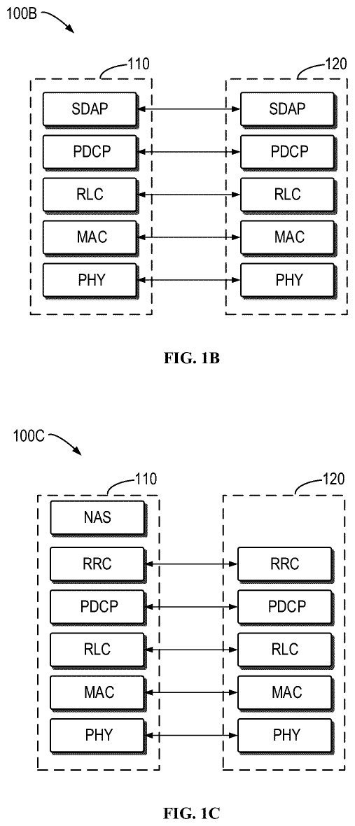

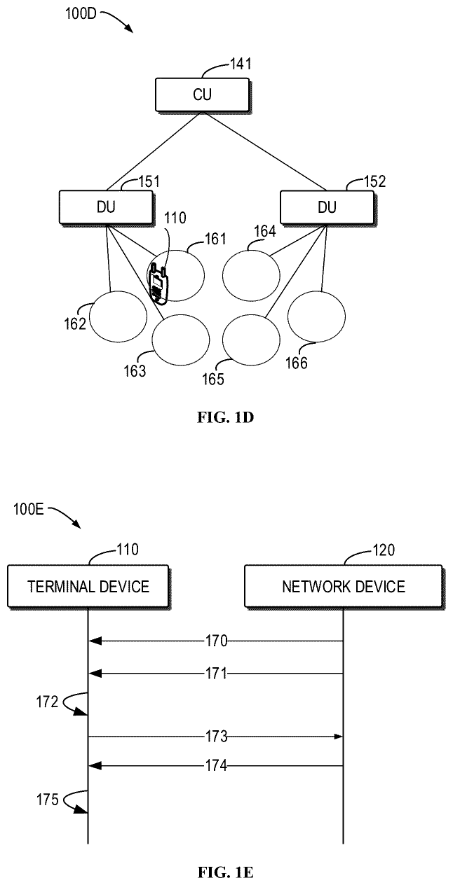

FIG. 1A illustrates a schematic diagram of an example communication network 100A in which some embodiments of the present disclosure can be implemented. As shown in FIG. 1A, the communication network 100A may include a terminal device 110 and a plurality of network devices 120 and 130 (for convenience, also referred to as a network device 120 and a network device 130 herein). The network devices 120 and 130 provide respective cells 121 and 131 to serve a terminal device.

It is to be understood that the number of devices in FIG. 1A is given for the purpose of illustration without suggesting any limitations to the present disclosure. The communication network 100A may include any suitable number of network devices and/or terminal devices adapted for implementing implementations of the present disclosure. Further, each of the network devices 120 and 130 may provide more cells for the terminal device 110.

As shown in FIG. 1A, the terminal device 110 may communicate with the network device 120 or 130 via a channel such as a wireless communication channel. The communications in the communication network 100A may conform to any suitable standards including, but not limited to, Global System for Mobile Communications (GSM), Long Term Evolution (LTE), LTE-Evolution, LTE-Advanced (LTE-A), New Radio (NR), Wideband Code Division Multiple Access (WCDMA), Code Division Multiple Access (CDMA), GSM EDGE Radio Access Network (GERAN), Machine Type Communication (MTC) and the like. The embodiments of the present disclosure may be performed according to any generation communication protocols either currently known or to be developed in the future. Examples of the communication protocols include, but not limited to, the first generation (1G), the second generation (2G), 2.5G, 2.75G, the third generation (3G), the fourth generation (4G), 4.5G, the fifth generation (5G) communication protocols, 5.5G, 5G-Advanced networks, or the sixth generation (6G) networks.

Communication in a direction from the terminal device 110 towards the network device 120 or 130 is referred to as uplink (UL) communication, while communication in a reverse direction from the network device 120 or 130 towards the terminal device 110 is referred to as downlink (DL) communication. The terminal device 110 can move amongst the cells of the network devices 120, 130 and possibly other network devices. In UL communication, the terminal device 110 may transmit UL data and control information to the network device 120 or 130 via a UL channel. In DL communication, the network device 120 or 130 may transmit DL data and control information to the terminal device 110 via a DL channel.

The communications in the communication network 100A can be performed in accordance with UP and CP protocol stacks. Generally speaking, for a communication device (such as a terminal device or a network device), there are a plurality of entities for a plurality of network protocol layers in a protocol stack, which can be configured to implement corresponding processing on data or signaling transmitted from the communication device and received by the communication device. FIG. 1B illustrates a schematic diagram 100B illustrating network protocol layer entities that may be established for UP protocol stack at devices according to some embodiments of the present disclosure. For convenience, the following description is given by taking a communication between the terminal device 110 and the network device 120 as an example. It is to be understood that the following description is also suitable for the communication between the terminal device 110 and the network device 130.

In some embodiments, the network devices 120 and 130 may be different network devices. In some embodiments, the network devices 120 and 130 may be the same network device.

As shown in FIG. 1B, in the UP, each of the terminal device 110 and the network device 120 may comprise an entity for the L1 layer, i.e., an entity for a physical (PHY) layer (also referred to as a PHY entity), and one or more entities for upper layers (L2 and layer 3 (L3) layers, or upper layers) including an entity for a media access control (MAC) layer (also referred to as a MAC entity), an entity for a radio link control (RLC) layer (also referred to as a RLC entity), an entity for a packet data convergence protocol (PDCP) layer (also referred to as a PDCP entity), and an entity for a service data application protocol (SDAP) layer (also referred to as a SDAP entity, which is established in 5G and higher-generation networks). In some cases, the PHY, MAC, RLC, PDCP, SDAP entities are in a stack structure.

FIG. 1C illustrates a schematic diagram 100C illustrating network protocol layer entities that may be established for CP protocol stack at devices according to some embodiments of the present disclosure. As shown in FIG. 1C, in the CP, each of the terminal device 110 and the network device 120 may comprise an entity for the L1 layer, i.e., an entity for a PHY layer (also referred to as a PHY entity), and one or more entities for upper layers (L2 and L3 layers) including an entity for a MAC layer (also referred to as a MAC entity), an entity for a RLC layer (also referred to as a RLC entity), an entity for a PDCP layer (also referred to as a PDCP entity), and an entity for a radio resource control (RRC) layer (also referred to as a RRC entity). The RRC layer may be also referred to as an access stratum (AS) layer, and thus the RRC entity may be also referred to as an AS entity. As shown in FIG. 1C, the terminal device 110 may also comprise an entity for a non-access stratum (NAS) layer (also referred to as a NAS entity). An NAS layer at the network side is not located in a network device and is located in a core network (CN, not shown). In some cases, these entities are in a stack structure.

In the context of the present disclosure, L1 refers to the PHY layer, L2 refers to the MAC or RLC or PDCP or SDAP layer, and L3 refers to the RRC layer. In the context of the present disclosure, L1 or L2 may also be collectively referred to as a lower-layer, and L3 may also be referred to as a higher-layer. Accordingly, L1 or L2 signaling may be also referred to as a lower-layer signaling, and L3 signaling may be also referred to as a higher-layer signaling.

Generally, communication channels are classified into logical channels, transmission channels and physical channels. The physical channels are channels that the PHY layer actually transmits information. For example, the physical channels may comprise a physical uplink control channel (PUCCH), a physical uplink shared channel (PUSCH), a physical random-access channel (PRACH), a PDCCH, a physical downlink shared channel (PDSCH) and a physical broadcast channel (PBCH).

The transmission channels are channels between the PHY layer and the MAC layer. For example, transmission channels may comprise a broadcast channel (BCH), a downlink shared channel (DL-SCH), a paging channel (PCH), an uplink shared channel (UL-SCH) and an random access channel (RACH).

The logical channels are channels between the MAC layer and the RLC layer. For example, the logical channels may comprise a dedicated control channel (DCCH), a common control channel (CCCH), a paging control channel (PCCH), broadcast control channel (BCCH) and dedicated traffic channel (DTCH).

Generally, channels between the RRC layer and PDCP layer are called as radio bearers. The terminal device 110 may be configured with at least one data radio bearer (DRB) for bearing data plane data and at least one signaling radio bearer (SRB) for bearing control plane data. Four types of SRBs may be defined in a RRC layer, i.e., SRB0, SRB1, SRB2 and SRB3. SRB0 uses a CCCH for RRC connection establishment or re-establishment. SRB1 uses a DCCH and is established when RRC connection is established. SRB2 uses a DCCH and is established during RRC reconfiguration and after initial security activation. SRB3 uses a DCCH and is established between the terminal device 110 and SN when a dual connection is established.

FIG. 1D illustrates a schematic diagram 100D of a CU/DU architecture in which some embodiments of the present disclosure can be implemented. The CU/DU architecture may be established at a network device.

As shown in FIG. 1D, CU 141 is shown. It is to be understood that more CUs may be comprised in the UP. The CU 141 may communicate with multiple DUs. Here, two DUs 151 and 152 are shown for illustration. It is to be understood that more DUs may also be provided for implementation of embodiments of the present disclosure. Although not shown, CU 141 may be responsible for accomplishing the functionalities of the SDAP entity and the PDCP entity, and DU 151 or 152 may be responsible for accomplishing the functionalities of the RLC entity, the MAC entity and the PHY entity.

DU 151 may communicate with transmission and reception points (TRPs) 161, 162 and 163. DU 152 may communicate with TRPs 164, 165 and 166. One or multiple cells may be supported within each TRP. It is to be understood that this is merely an example, and more or less TRPs are also feasible. The terminal device 110 may communicate with any of these TRPs.

In some embodiments, the terminal device 110 may switch from one TRP to another TRP under control of the same CU and same DU. For example, the terminal device 110 may be handed over from one cell of TRP 161 to another cell of TRP 162. This is called as an intra-CU intra-DU serving cell change. In some embodiments, the terminal device 110 may switch from one TRP to another TRP under control of the same CU and different DUs. For example, the terminal device 110 may be handed over from one cell of TRP 161 to another cell of TRP 164. In this case, a cell change from one cell of DU 151 to another cell of DU 152 will occur. This is called as an intra-CU inter-DU serving cell change. In another example, the terminal device 110 may be handed over from a cell of one TRP to a cell of another TRP under control of different CUs. In this case, a handover from a CU to another CU will occur. This is called as an inter-CU handover.

The network device 120 and the network device 130 may correspond to one or two devices under the same CU. In some embodiments, the network device 120 and the network device 130 may correspond to different TRPs under the same DU. In some embodiments, the network device 120 and the network device 130 may correspond to different TRPs under different DUs.

Return to FIG. 1A, in some embodiments, the terminal device 110 may be located within the coverage of cell 121 of the network device 120, and the terminal device 110 may communicate with the network device 120 based on network configuration. In this case, the cell 121 may be referred to as a serving cell of the terminal device 110.

In some embodiments, the terminal device 110 may establish a dual connection (i.e., simultaneous connection) with the network device 120 and another network device (not shown). In some embodiments, the network device 120 may serve as a master node (MN). In these embodiments, the terminal device 110 may communicate with the network device 120 via a set of serving cells. The set of serving cells form a MCG, and a primary cell in the MCG is called as PCell. In some scenarios, the PCell may be changed from the cell 121 to the cell 131. This is called as a handover. In some embodiments, the network device 120 may serve as a secondary node (SN). In these embodiments, the set of serving cells provided by the network device 120 form a SCG, and a primary cell in the SCG is called as PSCell. In some scenarios, the PSCell may be changed from the cell 121 to the cell 131. This is called as a PScell change.

In some scenarios, the terminal device 110 may receive, from the network device 120, a L1 or L2 signaling indicating an addition or change or release of a serving cell. Upon the addition or change or release of the serving cell, the terminal device 110 may perform a data transmission with an addition, modification or change of the serving cell. This procedure is called as the L1/L2 based mobility.

FIG. 1E illustrates a schematic diagram illustrating a process 100E of L1/L2 based mobility in which some embodiments of the present disclosure can be implemented. For the purpose of discussion, the process 100E will be described with reference to FIG. 1A. The process 100E may involve the terminal device 110 and the network device 120 as illustrated in FIG. 1A. The network device 120 may be a MN or SN serving the terminal device 110. In this example, the network device 120 provides a serving cell for the terminal device 110. The network device 130 does not provide a serving cell for the terminal device 110.

As shown in FIG. 1E, the network device 120 may transmit 170, to the terminal device 110, a RRC reconfiguration comprising a set of RRC configurations corresponding to a set of candidate cells allowing L1/L2 based mobility. The network device 120 may also transmit 171, to the terminal device 110, a configuration of beams (for example, a synchronization signal and physical broadcast channel block (SSB) or a channel state information-reference signal (CSI-RS)) of a candidate cell for L1 measurement.

The terminal device 110 may perform 172 the L1 measurement based on the configuration. If a certain condition is fulfilled by abeam, e.g., quality of the beam is above threshold quality, the terminal device 110 may report 173 an indication of the beam (e.g., an identity (ID) associated with the beam) to the network device 120.

The network device 120 may transmit 174, to the terminal device 110, a L1/L2 signaling (e.g., downlink control information (DCI) or a medium access control (MAC) control element (CE)). The L1/L2 signaling indicates that TCI state(s) for a cell among candidate cells are activated along with a cell change or addition.

Upon reception of the L1/L2 signaling, the terminal device 110 may perform 175 the cell change or addition. For example, the lower layer (e.g., PHY or MAC layer) of the terminal device 110 indicates, to the RRC layer of the terminal device 110, information of the cell change or addition, e.g. an ID associated with the target cell. Upon reception of the indication, the RRC layer performs the cell change or addition by applying the RRC configuration corresponding to the target cell. The target cell may be PCell, PSCell or SCell of the terminal device 110. And the terminal device 110 may start a data transmission with the target cell using a pre-configured UE-dedicated channel and the activated TCI states.

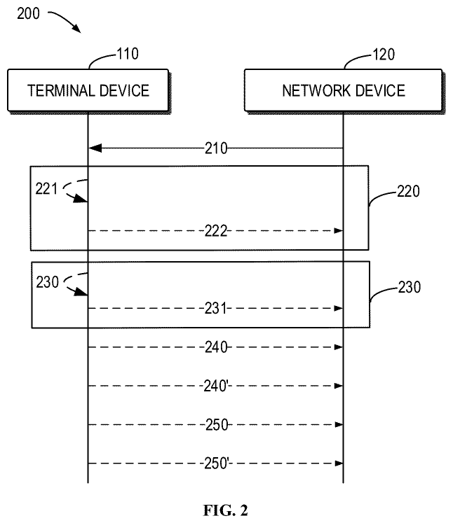

Embodiments of the present disclosure provide improve solutions for a L1/L2 based mobility procedure. Their details will be described with reference to FIGS. 2 to 3.

### Example Implementation of RA Procedure for Primary Cell

In traditional reconfiguration with sync (handover or PSCell change), a dedicated RA resource or CFRA resource may be provided in reconfigurationWithSync of RRCReconfiguration. The dedicated RA resource or reconfiguration with sync would be discarded upon completion of a RA procedure.

However, for L1/L2 based mobility, if the dedicated RA resource is configured in a RRC message, since UE dynamically changes among cells configured with L1/L2 based mobility, it results in the same dedicated RA resource maintained for the UE for a long time for each candidate cell. Further, if a network wants to de-configure the dedicated RA resource, another RRC message needs to be transmitted, which causes additional signaling overhead.

In view of this, embodiments of the present disclosure provide a solution of a lower-layer signaling ordered RA procedure (for convenience, may also referred to as MAC CE ordered RA procedure herein) to solve the above and other potential issues. For illustration, the solution will be described below in connection with FIG. 2.

FIG. 2 illustrates a schematic diagram illustrating a process 200 of performing a RA procedure in L1/L2 based mobility according to embodiments of the present disclosure. For the purpose of discussion, the process 200 will be described with reference to FIG. 1A. The process 200 may involve the terminal device 110 and the network device 120 as illustrated in FIG. 1A. The network device 120 may be a MN or SN serving the terminal device 110. In this example, the network device 120 provides a serving cell for the terminal device 110. The network device 130 does not provide a serving cell for the terminal device 110.

As shown in FIG. 2, the network device 120 transmits 210, to the terminal device 110, a lower-layer signaling (i.e., L1/L2 signaling) indicating a cell change or addition for a primary cell (i.e., a target cell) of the network device 130. For example, the lower-layer signaling may indicate a TCI state for the target cell. The lower-layer signaling further comprises a configuration (for convenience, may also referred to as a first configuration herein) for a CFRA procedure on the primary cell. In some embodiments, the cell change or addition may be a PCell change or addition. In some embodiments, the cell change or addition may be a PSCell change or addition.

For example, a lower-layer signaling may indicate a cell change from a serving cell of network device 120 to the cell of the network device 130. As another example, a lower-layer signaling may indicate an addition of the cell of the network device 130. The cell may be PCell or PSCell of the terminal device 110. In some embodiments, the lower-layer signaling may be carried in a MAC CE. In some embodiments, the lower-layer signaling may be carried in DCI. Of course, any other suitable forms are also feasible.

In some embodiments, the first configuration may comprise a RA preamble index. In some embodiments, the first configuration may comprise a PRACH occasion parameter, for example, a mask index (ra-ssb-OccasionMaskIndex) which defines PRACH occasion(s) associated with a SSB in which the MAC entity may transmit a RA preamble. In some embodiments, the first configuration may comprise an index of a RS (i.e., a beam index), for example, a SSB index or a CSI-RS index. In some embodiments, the first configuration may comprise a supplementary uplink (SUL) or normal uplink (NUL) indicator which indicates whether to perform a RA procedure in SUL or NUL. In some embodiments, the first configuration may comprise RA type information, for example, an explicit indication of 4-step RA or 2-step RA. It is to be understood that these are merely examples for illustration, and any other suitable information or combination of information is also feasible.

Continue to refer to FIG. 2, upon reception of the lower-layer signaling, the terminal device 110 performs 220 a RA procedure (for convenience, also referred to as a first RA procedure herein) on the primary cell at least based on the first configuration.

In some embodiments, the terminal device 110 may determine 221 a RA parameter (for convenience, also referred to as a first RA parameter herein) for a CFRA procedure towards the target cell. In some embodiments, the first RA parameter may comprise at least one of the following: a carrier, a RA type, a RS, a preamble, or a RA occasion.

In some embodiments, the terminal device 110 may determine the first RA parameter based on an indication of the first RA parameter in the first configuration. In some embodiments, the terminal device 110 may determine the first RA parameter based on a comparison between RSRP of a downlink pathloss reference and threshold power. In some embodiments, the terminal device 110 may determine the first RA parameter based on a predetermined value of the first RA parameter.

Upon determination of the first RA parameter, the terminal device 110 may perform 222 the first RA procedure based on the first RA parameter. For illustration, some example embodiments will be described below in connection with Embodiments 1 to 5.

### Embodiment 1

In this embodiment, the first RA parameter comprises a carrier, and the first configuration comprises a SUL or NUL indicator.

In some embodiments, the terminal device 110 may perform a carrier selection based on the SUL or NUL indicator indicated in the first configuration and perform the first RA procedure based on the selected carrier. In this way, UE has already performed beam measurement of the target cell and report measurement to the network. Thus, the network is aware of the radio link quality of the target cell, and the network can configure the target cell in a MAC CE which triggers L1/L2 based mobility directly. That is, there is no need to perform selection based on RSRP measured by the UE.

In some embodiments, the terminal device 110 may perform a carrier selection based on a comparison between RSRP of a downlink pathloss reference and threshold power. For example, if the RSRP of the downlink pathloss reference is below the threshold power, a SUL carrier may be selected. Otherwise, if the RSRP of the downlink pathloss reference is above or equal to the threshold power, a NUL carrier may be selected. It is to be understood that this is merely an example and is not intended for limitation. In this way, more dynamic carrier selection may be achieved since the latest RSRP of the target cell is considered.

### Embodiment 2

In this embodiment, the first RA parameter comprises a RA type, and the first configuration comprises RA type information.

In some embodiments, the terminal device 110 may perform a RA type selection based on the RA type information indicated in the first configuration and perform the first RA procedure based on the selected RA type. In this way, both 2-step RA and 4-step RA can be supported. Further, since UE has already performed and report beam measurement of the target cell to the network, the network is aware of the radio link quality of the target cell, so the network can configure the target cell in the MAC CE which triggers L1/L2 based mobility directly. That is, there is no need to perform selection based on RSRP measured by the UE.

In some embodiments, the terminal device 110 may perform a RA type selection based on a comparison between RSRP of a downlink pathloss reference and threshold power. For example, if both 2-step and 4-step RA are configured and if the RSRP of the downlink pathloss reference is above the threshold power, a 2-step RA may be selected. Otherwise, if the RSRP of the downlink pathloss reference is below or equal to the threshold power, a 4-step RA may be selected. It is to be understood that this is merely an example and is not intended for limitation. In this way, more dynamic RA type selection may be achieved since the latest RSRP of the target cell is considered.

In some embodiments, the terminal device 110 may perform a RA type selection based on a predetermined value of the RA type information. For example, only 4-step RA is supported for lower signaling ordered RA procedure. In this case, the terminal device 110 selects 4-step RA for the first RA procedure. In this way, lower-layer signaling ordered RA may be achieved in a simple way.

### Embodiment 3

In this embodiment, the first RA parameter comprises a RS, and the first configuration comprises an index of a RS.

In some embodiments, the terminal device 110 may perform a RS selection (i.e., beam selection) based on the index of the RS indicated in the first configuration and perform the first RA procedure based on the selected RS. In some embodiments, the RS may be SSB or CSI-RS. In this way, since UE has already performed and report beam measurement of the target cell to the network, the network is aware of the radio link quality of the target cell, so the network can configure target cell in the MAC CE which triggers L1/L2 based mobility directly. That is, there is no need to perform selection based on RSRP measured by the UE.

In some embodiments, the terminal device 110 may perform a RS selection based on a comparison between RSRP of a downlink pathloss reference and threshold power. In this way, more dynamic RS selection may be achieved since the latest RSRP of the target cell is considered.

For example, if at least one of SSBs with SS-RSRP is above the threshold power, a SSB with SS-RSRP above the threshold power may be selected. Otherwise, if all the SSBs with SS-RSRP are below or equal to the threshold power, any of the SSBs may be selected. As another example, if at least one of CSI-RSs with CSI-RSRP is above the threshold power, a CSI-RS with CSI-RSRP above the threshold power may be selected. Otherwise, if all the CSI-RSs with CSI-RSRP are below or equal to the threshold power, any of the CSI-RSs may be selected.

Alternatively, if no beam or RS is above the threshold power during the beam selection, the terminal device 110 may perform a contention based RA (CBRA) procedure, i.e., fallback to the CBRA procedure. It is to be understood that this is merely an example and is not intended for limitation.

### Embodiment 4

In this embodiment, the first RA parameter comprises a preamble, and the first configuration comprises a RA preamble index.

In some embodiments, the terminal device 110 may perform a preamble selection based on the RA preamble index indicated in the first configuration and perform the first RA procedure based on the selected preamble. In other words, the terminal device 110 selects the preamble index as indicated in the first configuration. In this way, the network may be aware that the RA is triggered for L1/L2 based mobility based on the preamble used, and may accept the UE immediately which shorten the RA latency for L1/L2 based mobility.

### Embodiment 5

In this embodiment, the first RA parameter comprises a RA occasion, and the first configuration comprises a PRACH occasion parameter.

In some embodiments, the terminal device 110 may perform a RA occasion selection based on the PRACH occasion parameter indicated in the first configuration and perform the first RA procedure based on the selected RA occasion. In this way, dedicated RA occasion configuration may be used for L1/L2 based mobility, and thus the possibility of successful transmission of preamble may be guaranteed which further shorten the latency of RA procedure for L1/L2 based mobility.

For example, the terminal device 110 may determine the next available PRACH occasion from PRACH occasions corresponding to the selected SSB permitted by restrictions given by a mask configuration in the first configuration in the L1/L2 signaling (e.g., MAC CE). It is to be understood that this is merely an example and is not intended for limitation.

### Example Implementation of RA Procedure for Scell

In traditional reconfiguration with sync (handover or PSCell change), MAC is reset, time alignment timers for all timing advance groups (TAGs) are considered as expiry. After UE perform random access to the target cell, the network has to send a PDCCH message to the UE to trigger the UE to perform random access to the SCells to obtain timing advance (TA) for the secondary timing advance groups (STAGs) and restart time alignment timers for the STAGs. However, if L1/L2 based mobility follows the same behavior, more than one L1/L2 signaling is required for the L1/L2 based mobility.

In view of this, embodiments of the present disclosure also provide a solution of a lower-layer signaling ordered RA procedure for a SCell. In the solution, in addition to the first configuration for the primary cell described above, the lower-layer signaling further comprises a configuration (for convenience, also referred to as a second configuration herein) for a CFRA procedure for a SCell of the network device 130.

The second configuration may be similar to the first configuration in contents. In some embodiments, the second configuration may comprise a RA preamble index. In some embodiments, the second configuration may comprise a PRACH occasion parameter, for example, a mask index (ra-ssb-OccasionMasklndex) which defines PRACH occasion(s) associated with a SSB in which the MAC entity may transmit a RA preamble. In some embodiments, the second configuration may comprise an index of a RS (i.e., a beam index), for example, a SSB index or a CSI-RS index. In some embodiments, the second configuration may comprise a supplementary uplink (SUL) or normal uplink (NUL) indicator which indicates whether to perform a RA procedure in SUL or NUL. In some embodiments, the second configuration may comprise RA type information, for example, an explicit indication of 4-step RA or 2-step RA. It is to be understood that these are merely examples for illustration, and any other suitable information or combination of information is also feasible.

Continue to refer to FIG. 2, the terminal device 110 may further perform 230 a RA procedure (for convenience, also referred to as a second RA procedure herein) on the SCell of the network device 130 at least based on the second configuration.

In some embodiments, the terminal device 110 may determine 231 a RA parameter (for convenience, also referred to as a second RA parameter herein) for a CFRA procedure towards the SCell. In some embodiments, the second RA parameter may comprise at least one of the following: a carrier, a RA type, a RS, a preamble, or a RA occasion.

In some embodiments, the terminal device 110 may determine the second RA parameter based on an indication of the second RA parameter in the second configuration. In some embodiments, the terminal device 110 may determine the second RA parameter based on a comparison between RSRP of a downlink pathloss reference and threshold power. In some embodiments, the terminal device 110 may determine the second RA parameter based on a predetermined value of the second RA parameter.

It is to be noted that contents of the second RA parameter are similar to contents of the first RA parameter, and the determination of the second RA parameter are similar to the determination of the first RA parameter. Embodiments 1 to 5 may also apply to the determination of the second RA parameter, and thus other details are not repeated here for concise.

Upon determination of the second RA parameter, the terminal device 110 may perform 232 a second RA procedure on the SCell based on the second RA parameter. In some embodiments, the terminal device may transmit a RA preamble on the SCell, and receive a random access response (RAR) on the primary cell. For example, the preamble transmission takes place on the indicated SCell, and the RAR takes place on PCell or PSCell.

In this way, only one L1/L2 signaling is needed for L1/L2 based mobility, and latency may be reduced for the use of SCells.

### Example Implementation of RA Report

Currently, upon successful completion of one RA procedure, the UE can store RA related information and report to the network to help the network to adjust the RA related configuration. This feature is called a RA report, wherein a field raPurpose is stored to indicate a RA scenario for which the RA report entry is triggered. For a lower-layer signaling ordered RA procedure, what is the raPurpose needs to be discussed.

In view of this, embodiments of the present disclosure also provide a solution of a RA report so that the network is aware of the purpose of the RA triggered by a lower-layer signaling (e.g., MAC CE).

Continue to refer to FIG. 2, for the first RA procedure for the primary cell, the terminal device 110 may transmit 240 a RA report comprising an indicator (for convenience, also referred to as a first indicator herein) to the network device 120. The first indicator is used for indicating a RA scenario for which a RA report is triggered upon execution of a reconfiguration with sync. For example, the first indicator may be reconfigurationWithSync. For example, for a RA procedure initiated in a SpCell by MAC CE, the indicator reconfigurationWithSync is used.

In some alternative embodiments, the terminal device 110 may transmit 240′, to the network device 120, a RA report comprising an indicator (for convenience, also referred to as a second indicator herein) dedicated to indicate that the first RA procedure is initiated in the primary cell by the lower-layer signaling.

In this way, the network is aware of the purpose of the RA triggered by a lower-layer signaling (e.g., MAC CE) for a PCell or PSCell.

Continue to refer to FIG. 2, for the second RA procedure for the SCell, the terminal device 110 may transmit 250 a RA report comprising an indicator (for convenience, also referred to as a third indicator herein) to the network device 120. The third indicator is used for indicating a RA scenario for which a RA report is triggered if a RA procedure is initiated in a primary cell by DL or UL data arrival during a connected state of the terminal device 110 when a time alignment timer is not running in a primary timing advance group (PTAG) or if a RA procedure is initiated in a serving cell by a PDCCH order. For example, the third indicator is ulUnSynchronized. For example, for a RA procedure initiated in a Scell by a MAC CE, the indicator ulUnSynchronized is used. In other words, the indicator ulUnSynchronized is reused to indicate RA scenario for the case of RA triggered by a lower-layer signaling (e.g., MAC CE) on the SCell.

In some alternative embodiments, the terminal device 110 may transmit 250′, to the network device 120, a RA report comprising an indicator (for convenience, also referred to as a fourth indicator herein) dedicated to indicate that the second RA procedure is initiated in the SCell by the lower-layer signaling.

In this way, the network is aware of the purpose of the RA triggered by a lower-layer signaling (e.g., MAC CE) for a SCell.

### Example Implementation of MAC Reset Procedure

The traditional reconfiguration with sync procedure involves a MAC reset procedure during which all data processing related procedure would be stopped and cleared. If for L1/L2 based reconfiguration with sync, the traditional MAC reset behavior is performed, it will lead to long service interruption which is unacceptable for L1/L2 based reconfiguration with sync procedure.

In view of this, embodiments of the present disclosure provide a solution for a MAC reset procedure. This solution will be described in connection with FIG. 3.

FIG. 3 illustrates a schematic diagram illustrating a process 300 of performing a MAC reset procedure according to embodiments of the present disclosure. For the purpose of discussion, the process 300 will be described with reference to FIG. TA. The process 300 may involve the terminal device 110 and the network device 120 as illustrated in FIG. 1A. The network device 120 may be a MN or SN serving the terminal device 110. In this example, the network device 120 provides a serving cell for the terminal device 110. The network device 130 does not provide a serving cell for the terminal device 110.

As shown in FIG. 3, the network device 120 transmits 310, to the terminal device 110, a lower-layer signaling (i.e., L1/L2 signaling) indicating a cell change or addition for a cell (i.e., a target cell) of the network device 130. In some embodiments, the cell change or addition may be a PCell change or addition. In some embodiments, the cell change or addition may be a PSCell change or addition.

For example, a lower-layer signaling may indicate a cell change from a serving cell of network device 120 to the cell of the network device 130. As another example, a lower-layer signaling may indicate an addition of the cell of the network device 130. The cell may be PCell or PSCell of the terminal device 110. In some embodiments, the lower-layer signaling may be carried in a MAC CE. In some embodiments, the lower-layer signaling may be carried in DCI. Of course, any other suitable forms are also feasible.

Upon reception of the lower-layer signaling, the terminal device 110 maintains 320 a data processing related procedure in a MAC layer. In other words, for reconfiguration with sync triggered by L1/L2 based signaling, the terminal device 110 continues the data processing related procedure in the MAC layer.

In some embodiments, the terminal device 110 may receive 321, from the network device 120, an indication indicating whether the maintaining is to be performed. In some embodiments, the terminal device 110 may receive the indication in the lower-layer signaling. In some embodiments, the terminal device 110 may receive the indication in a RRC reconfiguration for candidate cells for the cell change or addition.

If the indication indicates that the maintaining is to be performed, the terminal device 110 may maintain 322 the data processing related procedure.

In some embodiments, the terminal device 110 may maintain a variable (for example, Bj) of the terminal device 110 used for a logical channel prioritization procedure. For example, the terminal device 110 may not reset Bj for each logical channel to zero.

In some embodiments, the terminal device 110 may maintain a triggered scheduling request procedure. For example, the terminal device 110 may not cancel the triggered scheduling request procedure.

In some embodiments, the terminal device 110 may maintain a triggered buffer status reporting procedure. For example, the terminal device 110 may not cancel the triggered buffer status reporting procedure.

In some embodiments, the terminal device 110 may maintain at least one buffer for at least one hybrid automatic repeat request (HARQ) process. For example, the terminal device 110 may not clear buffers for all HARQ processes. For example, the terminal device 110 may maintain buffers for all HARQ processes.

In some embodiments, the terminal device 110 may maintain at least one new data indicator (NDI) for at least one HARQ process. For example, the terminal device 110 may not set the NDI to zero for all uplink HARQ processes.

In some embodiments, the terminal device 110 may maintain at least one time alignment timer for at least one TAG. For example, the terminal device 110 may not consider time alignment timers for all TAGs as expiry. For example, the terminal device 110 may maintain time alignment timers for all TAGs.

It is to be understood that these are merely examples, and the terminal device 110 may maintain any other suitable data processing related procedures.

In some embodiments for maintaining the data processing related procedure, the terminal device 110 may skip the MAC reset procedure. In other words, a RRC layer of the terminal device 110 does not trigger (i.e., skips) the MAC reset procedure during L1/L2 based reconfiguration with sync procedure.

In some embodiments for maintaining the data processing related procedure, the terminal device 110 may perform a dedicated MAC reset procedure for the L1/L2 based cell change or addition, the dedicated MAC reset procedure being configured to maintain the data processing related procedure. For example, the dedicated MAC reset procedure may comprise at least one of the following: stopping all timers if running; stopping ongoing random access procedure if any; discarding explicitly signaled CFRA resources for 4-step RA type and 2-step RA type if any; flushing Msg3 buffer; flushing MSGA buffer; cancelling a triggered power headroom reporting procedure if any; cancelling a triggered consistent listen before talk (LBT) failure if any; cancelling a triggered beam failure report (BFR) if any; cancelling a triggered recommended bit rate query procedure if any; cancelling a triggered configuration uplink grant configuration if any; cancelling a triggered desired guard symbol query if any; releasing temporary cell-radio network temporary identifier (C-RNTI) if any; resetting all BFI counters; or resetting all LBT counters.

In some embodiments, if a MAC reset procedure is not triggered by the lower-layer signaling based mobility procedure, the terminal device 110 may stop 330 the data processing related procedure in the MAC layer. For example, during a MAC reset procedure, UE checks if the MAC reset procedure is triggered due to L1/L2 based mobility, if not, the UE may perform at least one of the following: resetting Bj for each logical channel to zero; cancelling a triggered scheduling request procedure; cancelling a triggered buffer status reporting procedure; clearing buffers for all HARQ processes; setting NDI to zero for all uplink HARQ processes; or considering the timeAlignmentTimer for all TAGs as expiry.

With the process 300, data transmission is not interrupted and the service interruption may be reduced for some scenarios such as intra DU handover or PSCell change.

### Example Implementation of Methods

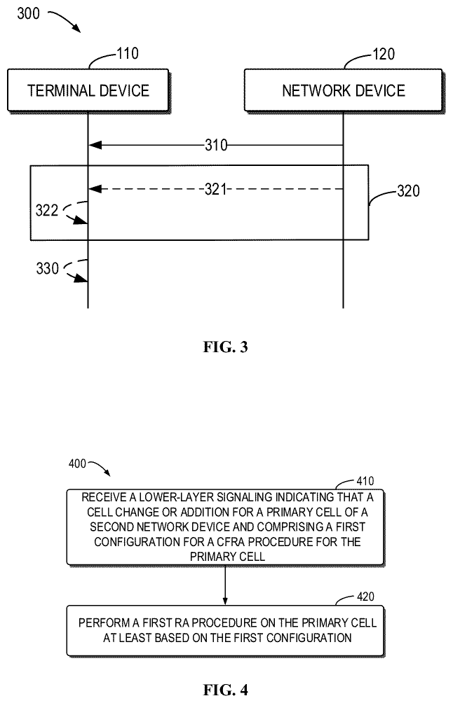

Accordingly, embodiments of the present disclosure provide methods of communication implemented at a terminal device and a network device. These methods will be described below with reference to FIGS. 4 to 7.

FIG. 4 illustrates an example method 400 of communication implemented at a terminal device in accordance with some embodiments of the present disclosure. For example, the method 400 may be performed at the terminal device 110 as shown in FIG. 1A. For the purpose of discussion, in the following, the method 400 will be described with reference to FIG. 1A. It is to be understood that the method 400 may include additional blocks not shown and/or may omit some blocks as shown, and the scope of the present disclosure is not limited in this regard. Assuming that the network device 120 may be a MN or SN serving the terminal device 110. The network device 120 provides a serving cell (for example, the cell 121) for the terminal device 110. The network device 130 does not provide a serving cell for the terminal device 110.

At block 410, the terminal device 110 receives, from a first network device (for example, the network device 120), a lower-layer signaling indicating that a cell change or addition for a primary cell (for example, the cell 131) of a second network device (for example, the network device 130) and comprising a first configuration for a CFRA procedure for the primary cell.

At block 420, the terminal device 110 performs, at least based on the first configuration, a first RA procedure on the primary cell.

In some embodiments, the terminal device 110 may determine a first RA parameter based on an indication of the first RA parameter in the first configuration, and perform the first RA procedure based on the first RA parameter.

In some embodiments, the terminal device 110 may determine a first RA parameter based on a comparison between RSRP of a downlink pathloss reference and threshold power; and perform the first RA procedure based on the first RA parameter.

In some embodiments, the terminal device 110 may determine a first RA parameter based on a predetermined value of the first RA parameter, and perform the first RA procedure based on the first RA parameter.

In some embodiments, the first RA parameter may comprise at least one of the following: a carrier, a RA type, a reference signal, a preamble, or a RA occasion.

In some embodiments, the first configuration comprises at least one of the following: a RA preamble index, a PRACH occasion parameter, an index of a reference signal, a supplementary or normal uplink indicator, or RA type information.

In some embodiments, the lower-layer signaling further comprises a second configuration for a contention free RA procedure for a secondary cell of the second network device. In these embodiments, the terminal device 110 may determine a second RA parameter for the secondary cell based on an indication of the second RA parameter in the second configuration, and perform a second RA procedure on the secondary cell based on the second RA parameter.

In some embodiments, the terminal device 110 may determine a second RA parameter based on a comparison between reference signal receive power of a downlink pathloss reference and threshold power, and perform a second RA procedure based on the second RA parameter.

In some embodiments, the terminal device 110 may determine a second RA parameter based on a predetermined value of the first RA parameter, and perform a second RA procedure based on the second RA parameter.

In some embodiments, the terminal device 110 may perform the second RA procedure by: transmitting a RA preamble on the secondary cell; and receiving a RAR on the primary cell.

In some embodiments, the second RA parameter comprises at least one of the following: a carrier, a RA type, a reference signal, a preamble, or a RA occasion.

In some embodiments, the second configuration comprises at least one of the following: a RA preamble index, a PRACH occasion parameter, an index of a RS, a SUL or NUL indicator, or RA type information.

In some embodiments, the terminal device 110 may transmit, to the network device 120, a RA report comprising a first indicator, the first indicator being used for indicating a RA scenario for which a RA report is triggered upon execution of a reconfiguration with sync. In some embodiments, the terminal device 110 may transmit, to the network device 120, a RA report comprising a second indicator dedicated to indicate that the first RA procedure is initiated in the primary cell by the lower-layer signaling.

In some embodiments, the terminal device 110 may transmit, to the network device 120, a RA report comprising a third indicator, the third indicator being used for indicating a RA scenario for which a RA report is triggered if a RA procedure is initiated in a primary cell by downlink or uplink data arrival during a connected state of the terminal device when a time alignment timer is not running in a primary timing advance group or if a RA procedure is initiated in a serving cell by a physical downlink control channel order. In some embodiments, the terminal device 110 may transmit, to the network device 120, a RA report comprising a fourth indicator to indicate that the second RA procedure is initiated in the secondary cell by a lower-layer signaling.

With the method 400, a dynamic CFRA procedure may be achieved for L1/L2 based mobility.

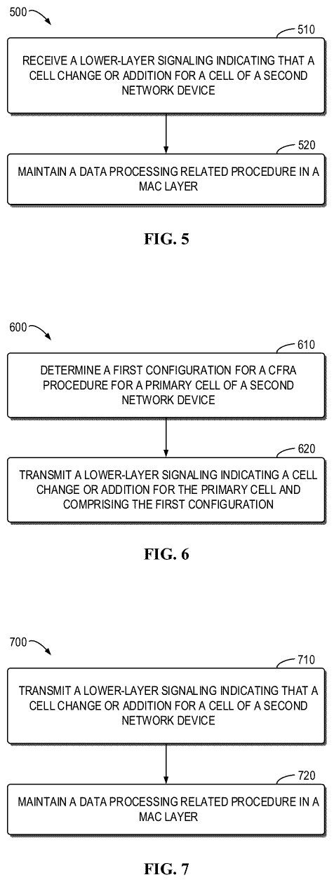

FIG. 5 illustrates another example method 500 of communication implemented at a terminal device in accordance with some embodiments of the present disclosure. For example, the method 500 may be performed at the terminal device 110 as shown in FIG. TA. For the purpose of discussion, in the following, the method 500 will be described with reference to FIG. TA. It is to be understood that the method 500 may include additional blocks not shown and/or may omit some blocks as shown, and the scope of the present disclosure is not limited in this regard. Assuming that the network device 120 may be a MN or SN serving the terminal device 110. The network device 120 provides a serving cell (for example, the cell 121) for the terminal device 110. The network device 130 does not provide a serving cell for the terminal device 110.

At block 510, the terminal device 110 receives, from a first network device (for example, the network device 120), a lower-layer signaling indicating that a cell change or addition for a cell (for example, the cell 131) of a second network device (for example, the network device 130).

At block 520, the terminal device 110 maintains a data processing related procedure in a medium access control layer.

In some embodiments, the terminal device 110 may maintain the data processing related procedure by at least one of maintaining a variable of the terminal device used for a logical channel prioritization procedure; maintaining a triggered scheduling request procedure; maintaining a triggered buffer status reporting procedure; maintaining at least one buffer for at least one hybrid automatic repeat request process; maintaining at least one new data indicator for at least one hybrid automatic repeat request process; or maintaining at least one time alignment timer for at least one timing advance group.

In some embodiments, the terminal device 110 may receive, from the network device 120, an indication indicating whether the maintaining is to be performed. If the indication indicates that the maintaining is to be performed, the terminal device 110 may maintain the data processing related procedure.

In some embodiments, the terminal device 110 may receive the indication in the lower-layer signaling. In some embodiments, the terminal device 110 may receive the indication in a radio resource control reconfiguration for candidate cells for the cell change or addition.

In some embodiments, the terminal device 110 may maintain the data processing related procedure by: skipping a medium access control reset procedure; or performing a dedicated medium access control reset procedure for the cell change or addition, the dedicated medium access control reset procedure being configured to maintain the data processing related procedure.

In some embodiments, if a medium access control reset procedure is not triggered by the lower-layer signaling, the terminal device 110 may stop the data processing related procedure in the medium access control layer.

With the method 500, a data processing related procedure in a MAC reset may be maintained for L1/L2 based mobility. Thus, data transmission may be not interrupted, and service interruption may be reduced.

FIG. 6 illustrates an example method 600 of communication implemented at a network device in accordance with some embodiments of the present disclosure. For example, the method 600 may be performed at the network device 120 or 130 as shown in FIG. 1A. For the purpose of discussion, in the following, the method 600 will be described with reference to FIG. 1A. It is to be understood that the method 600 may include additional blocks not shown and/or may omit some blocks as shown, and the scope of the present disclosure is not limited in this regard. Assuming that the network device 120 may be a MN or SN serving the terminal device 110. The network device 120 provides a serving cell (for example, the cell 121) for the terminal device 110. The network device 130 does not provide a serving cell for the terminal device 110.

As shown in FIG. 6, at block 610, a first network device (for example, the network device 120) determines a first configuration for a CFRA procedure for a primary cell of a second network device (for example, the network device 130).

In some embodiments, the network device 120 determines a first RA parameter for a first RA procedure on the primary cell, and generates the first configuration comprising an indication of the first RA parameter.

In some embodiments, the first RA parameter comprises at least one of the following: a carrier, a RA type, a RS, a preamble, or a RA occasion.

In some embodiments, the first configuration comprises at least one of the following: a RA preamble index, a PRACH occasion parameter, an index of a RS, a SUL or NUL indicator, or RA type information.

At block 620, the network device 120 transmits, to the terminal device 110, a lower-layer signaling indicating a cell change or addition for the primary cell and comprising the first configuration.

In some embodiments, the lower-layer signaling may further comprise a second configuration for a CFRA procedure for a secondary cell of the network device 130.

In some embodiments, the network device 120 may determine a second RA parameter for a second RA procedure on the secondary cell; and generate the second configuration comprising an indication of the second RA parameter.

In some embodiments, the network device 120 may receive a RA preamble for the second RA procedure on the secondary cell; and transmit a RAR for the second RA procedure on the primary cell.

In some embodiments, the second RA parameter comprises at least one of the following: a carrier, a RA type, a RS, a preamble, or a RA occasion.

In some embodiments, the second configuration comprises at least one of the following: a RA preamble index, a PRACH occasion parameter, an index of a RS, a SUL or NUL indicator, or RA type information.

In some embodiments, the network device 120 may receive, from the terminal device 110, a RA report comprising a first indicator, the first indicator being used for indicating a RA scenario for which a RA report is triggered upon execution of a reconfiguration with sync. In some embodiments, the network device 120 may receive, from the terminal device 110, a RA report comprising a second indicator dedicated to indicate that the first RA procedure is initiated in the primary cell by the lower-layer signaling.

In some embodiments, the network device 120 may receive, from the terminal device 110, a RA report comprising a third indicator, the third indicator being used for indicating a RA scenario for which a RA report is triggered if a RA procedure is initiated in a primary cell by downlink or uplink data arrival during a connected state of the terminal device when a time alignment timer is not running in a primary timing advance group or if a RA procedure is initiated in a serving cell by a physical downlink control channel order. In some embodiments, the network device 120 may receive, from the terminal device 110, a RA report comprising a fourth indicator to indicate that the second RA procedure is initiated in the secondary cell by a lower-layer signaling.

With the method 600, a dynamic configuration for a CFRA resource may be achieved for L1/L2 based mobility.

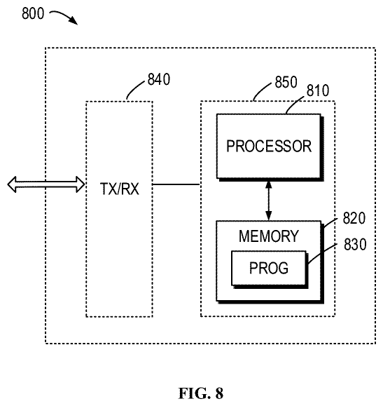

FIG. 7 illustrates another example method 700 of communication implemented at a network device in accordance with some embodiments of the present disclosure. For example, the method 700 may be performed at the network device 120 or 130 as shown in FIG. 1A. For the purpose of discussion, in the following, the method 700 will be described with reference to FIG. 1A. It is to be understood that the method 700 may include additional blocks not shown and/or may omit some blocks as shown, and the scope of the present disclosure is not limited in this regard. Assuming that the network device 120 may be a MN or SN serving the terminal device 110. The network device 120 provides a serving cell (for example, the cell 121) for the terminal device 110. The network device 130 does not provide a serving cell for the terminal device 110.

As shown in FIG. 7, at block 710, a first network device (for example, the network device 120) transmits, to the terminal device 110, a lower-layer signaling indicating that a cell change or addition for a cell of a second network device (for example, the network device 130).

At block 720, the network device 120 maintains a data processing related procedure in a medium access control layer.

In some embodiments, the network device 120 may maintain the data processing related procedure by at least one of maintaining a variable of the terminal device used for a logical channel prioritization procedure; maintaining a triggered scheduling request procedure; maintaining a triggered buffer status reporting procedure; maintaining at least one buffer for at least one hybrid automatic repeat request process; maintaining at least one new data indicator for at least one hybrid automatic repeat request process; or maintaining at least one time alignment timer for at least one timing advance group.

In some embodiments, the network device 120 may transmit, to the terminal device 110, an indication indicating whether the maintaining is to be performed.

In some embodiments, the network device 120 may transmit the indication in the lower-layer signaling. In some embodiments, the network device 120 may transmit the indication in a radio resource control reconfiguration for candidate cells for the cell change or addition.

In some embodiments, the network device 120 may maintain the data processing related procedure by: skipping a medium access control reset procedure; or performing a dedicated medium access control reset procedure for the cell change or addition, the dedicated medium access control reset procedure being configured to maintain the data processing related procedure.

In some embodiments, if a medium access control reset procedure is not triggered by the lower-layer signaling, the network device 120 may stop the data processing related procedure in the medium access control layer.

With the method 700, a data processing related procedure in a MAC reset may be maintained for L1/L2 based mobility. Thus, data transmission may be not interrupted, and service interruption may be reduced.

It is to be understood that the operations of methods 400 to 700 are similar as that described in connection with FIGS. 2 to 3, and thus other details are not repeated here for concise.

### Example Implementation of Device Sand Apparatuses

FIG. 8 is a simplified block diagram of a device 800 that is suitable for implementing embodiments of the present disclosure. The device 800 can be considered as a further example implementation of the terminal device 110 or the network device 120 or the network device 130 as shown in FIG. 1A. Accordingly, the device 800 can be implemented at or as at least a part of the terminal device 110 or the network device 120 or the network device 130.

As shown, the device 800 includes a processor 810, a memory 820 coupled to the processor 810, a suitable transmitter (TX) and receiver (RX) 840 coupled to the processor 810, and a communication interface coupled to the TX/RX 840. The memory 810 stores at least a part of a program 830. The TX/RX 840 is for bidirectional communications. The TX/RX 840 has at least one antenna to facilitate communication, though in practice an Access Node mentioned in this application may have several ones. The communication interface may represent any interface that is necessary for communication with other network elements, such as X2/Xn interface for bidirectional communications between eNBs/gNBs, S1/NG interface for communication between a Mobility Management Entity (MME)/Access and Mobility Management Function (AMF)/SGW/UPF and the eNB/gNB, Un interface for communication between the eNB/gNB and a relay node (RN), or Uu interface for communication between the eNB/gNB and a terminal device.

The program 830 is assumed to include program instructions that, when executed by the associated processor 810, enable the device 800 to operate in accordance with the embodiments of the present disclosure, as discussed herein with reference to FIGS. 1A to 7. The embodiments herein may be implemented by computer software executable by the processor 810 of the device 800, or by hardware, or by a combination of software and hardware. The processor 810 may be configured to implement various embodiments of the present disclosure. Furthermore, a combination of the processor 810 and memory 820 may form processing means 850 adapted to implement various embodiments of the present disclosure.

The memory 820 may be of any type suitable to the local technical network and may be implemented using any suitable data storage technology, such as a non-transitory computer readable storage medium, semiconductor based memory devices, magnetic memory devices and systems, optical memory devices and systems, fixed memory and removable memory, as non-limiting examples. While only one memory 820 is shown in the device 800, there may be several physically distinct memory modules in the device 800. The processor 810 may be of any type suitable to the local technical network, and may include one or more of general purpose computers, special purpose computers, microprocessors, digital signal processors (DSPs) and processors based on multicore processor architecture, as non-limiting examples. The device 800 may have multiple processors, such as an application specific integrated circuit chip that is slaved in time to a clock which synchronizes the main processor.

In some embodiments, a terminal device comprises a circuitry configured to: receive, at a terminal device and from a first network device, a lower-layer signaling indicating a cell change or addition for a primary cell of a second network device, the lower-layer signaling comprising a first configuration for a contention free random access procedure for the primary cell; and perform, at least based on the first configuration, a first random access procedure on the primary cell.

In some embodiments, the circuitry may be configured to perform the first random access procedure by: determining a first random access parameter based on an indication of the first random access parameter in the first configuration; and performing the first random access procedure based on the first random access parameter.

In some embodiments, the circuitry may be configured to perform the first random access procedure by: determining a first random access parameter based on a comparison between reference signal receive power of a downlink pathloss reference and threshold power; and performing the first random access procedure based on the first random access parameter.

In some embodiments, the circuitry may be configured to perform the first random access procedure by: determining a first random access parameter based on a predetermined value of the first random access parameter; and performing the first random access procedure based on the first random access parameter.

In some embodiments, the first random access parameter comprises at least one of the following: a carrier, a random access type, a reference signal, a preamble, or a random access occasion.

In some embodiments, the first configuration comprises at least one of the following: a random access preamble index, a physical random access channel occasion parameter, an index of a reference signal, a supplementary or normal uplink indicator, or random access type information.

In some embodiments, the lower-layer signaling further comprises a second configuration for a contention free random access procedure for a secondary cell of the second network device.

In some embodiments, the circuitry may be further configured to: determine a second random access parameter for the secondary cell based on an indication of the second random access parameter in the second configuration; and perform a second random access procedure on the secondary cell based on the second random access parameter.

In some embodiments, the circuitry may be further configured to: determine a second random access parameter based on a comparison between reference signal receive power of a downlink pathloss reference and threshold power; and perform a second random access procedure based on the second random access parameter.

In some embodiments, the circuitry may be further configured to: determine a second random access parameter based on a predetermined value of the first random access parameter; and perform a second random access procedure based on the second random access parameter.

In some embodiments, the circuitry may be configured to perform the second random access procedure by: transmitting a random access preamble on the secondary cell; and receiving a random access response on the primary cell.

In some embodiments, the second random access parameter comprises at least one of the following: a carrier, a random access type, a reference signal, a preamble, or a random access occasion.

In some embodiments, the second configuration comprises at least one of the following: a random access preamble index, a physical random access channel occasion parameter, an index of a reference signal, a supplementary or normal uplink indicator, or random access type information.

In some embodiments, the circuitry may be further configured to: transmit, to the first network device, a random access report comprising a first indicator, the first indicator being used for indicating a random access scenario for which a random access report is triggered upon execution of a reconfiguration with sync; or transmit, to the first network device, a random access report comprising a second indicator dedicated to indicate that the first random access procedure is initiated in the primary cell by the lower-layer signaling.

In some embodiments, the circuitry may be further configured to: transmit, to the first network device, a random access report comprising a third indicator, the third indicator being used for indicating a random access scenario for which a random access report is triggered if a random access procedure is initiated in a primary cell by downlink or uplink data arrival during a connected state of the terminal device when a time alignment timer is not running in a primary timing advance group or if a random access procedure is initiated in a serving cell by a physical downlink control channel order; or transmit, to the first network device, a random access report comprising a fourth indicator to indicate that the second random access procedure is initiated in the secondary cell by a lower-layer signaling.

In some embodiments, a terminal device comprises a circuitry configured to: receive, at a terminal device and from a first network device, a lower-layer signaling indicating a cell change or addition for a cell of a second network device; and maintain a data processing related procedure in a medium access control layer.

In some embodiments, the circuitry may be configured to maintain the data processing related procedure comprises at least one of: maintaining a variable of the terminal device used for a logical channel prioritization procedure; maintaining a triggered scheduling request procedure; maintaining a triggered buffer status reporting procedure; maintaining at least one buffer for at least one hybrid automatic repeat request process; maintaining at least one new data indicator for at least one hybrid automatic repeat request process; or maintaining at least one time alignment timer for at least one timing advance group.

In some embodiments, the circuitry may be configured to maintain the data processing related procedure by: receiving, from the first network device, an indication indicating whether the maintaining is to be performed; and in accordance with a determination that the indication indicates that the maintaining is to be performed, maintaining the data processing related procedure.

In some embodiments, the circuitry may be configured to receive the indication by: receiving the indication in the lower-layer signaling; or receiving the indication in a radio resource control reconfiguration for candidate cells for the cell change or addition.

In some embodiments, the circuitry may be configured to maintain the data processing related procedure by: skipping a medium access control reset procedure; or performing a dedicated medium access control reset procedure for the cell change or addition, the dedicated medium access control reset procedure being configured to maintain the data processing related procedure.

In some embodiments, a circuitry may be further configured to: in accordance with a determination that a medium access control reset procedure is not triggered by the lower-layer signaling, stop the data processing related procedure in the medium access control layer.

In some embodiments, a first network device comprises a circuitry configured to: determine, at a first network device, a first configuration for a contention free random access procedure for a primary cell of a second network device; and transmit, to a terminal device, a lower-layer signaling indicating a cell change or addition for the primary cell and comprising the first configuration.

In some embodiments, the circuitry may be configured to determine the first configuration by: determining a first random access parameter for a first random access procedure on the primary cell; and generating the first configuration comprising an indication of the first random access parameter.

In some embodiments, the first random access parameter comprises at least one of the following: a carrier, a random access type, a reference signal, a preamble, or a random access occasion.

In some embodiments, the first configuration comprises at least one of the following: a random access preamble index, a physical random access channel occasion parameter, an index of a reference signal, a supplementary or normal uplink indicator, or random access type information.

In some embodiments, the lower-layer signaling further comprises a second configuration for a contention free random access procedure for a secondary cell of the second network device.

In some embodiments, the circuitry may be further configured to: determine a second random access parameter for a second random access procedure on the secondary cell; and generate the second configuration comprising an indication of the second random access parameter.

In some embodiments, the circuitry may be further configured to: receive a random access preamble for the second random access procedure on the secondary cell; and transmit a random access response for the second random access procedure on the primary cell.

In some embodiments, the second random access parameter comprises at least one of the following: a carrier, a random access type, a reference signal, a preamble, or a random access occasion.

In some embodiments, the second configuration comprises at least one of the following: a random access preamble index, a physical random access channel occasion parameter, an index of a reference signal, a supplementary or normal uplink indicator, or random access type information.

In some embodiments, the circuitry may be further configured to: receive, from the terminal device, a random access report comprising a first indicator, the first indicator being used for indicating a random access scenario for which a random access report is triggered upon execution of a reconfiguration with sync; or receive, from the terminal device, a random access report comprising a second indicator dedicated to indicate that the first random access procedure is initiated in the primary cell by the lower-layer signaling.

In some embodiments, the circuitry may be further configured to: receive, from the terminal device, a random access report comprising a third indicator, the third indicator being used for indicating a random access scenario for which a random access report is triggered if a random access procedure is initiated in a primary cell by downlink or uplink data arrival during a connected state of the terminal device when a time alignment timer is not running in a primary timing advance group or if a random access procedure is initiated in a serving cell by a physical downlink control channel order; or receive, from the terminal device, a random access report comprising a fourth indicator to indicate that the second random access procedure is initiated in the secondary cell by a lower-layer signaling.

In some embodiments, a first network device comprises a circuitry configured to: transmit, at a first network device and to a terminal device, a lower-layer signaling indicating a cell change or addition for a cell of a second network device; and maintain a data processing related procedure in a medium access control layer.

In some embodiments, the circuitry may be configured to maintain the data processing related procedure by at least one of: maintaining a variable of the terminal device used for a logical channel prioritization procedure; maintaining a triggered scheduling request procedure; maintaining a triggered buffer status reporting procedure; maintaining at least one buffer for at least one hybrid automatic repeat request process; maintaining at least one new data indicator for at least one hybrid automatic repeat request process; or maintaining at least one time alignment timer for at least one timing advance group.

In some embodiments, the circuitry may be further configured to: transmit, to a terminal device, an indication indicating whether the maintaining is to be performed.

In some embodiments, the circuitry may be configured to transmit the indication by: transmitting the indication in the lower-layer signaling; or transmitting the indication in a radio resource control reconfiguration for candidate cells for the cell change or addition.

In some embodiments, the circuitry may be configured to maintain the data processing related procedure by: skipping a medium access control reset procedure; or performing a dedicated medium access control reset procedure for the cell change or addition, the dedicated medium access control reset procedure being configured to maintain the data processing related procedure.

In some embodiments, the circuitry may be further configured to: in accordance with a determination that a medium access control reset procedure is not triggered by the lower-layer signaling, stop the data processing related procedure in the medium access control layer.

The term “circuitry” used herein may refer to hardware circuits and/or combinations of hardware circuits and software. For example, the circuitry may be a combination of analog and/or digital hardware circuits with software/firmware. As a further example, the circuitry may be any portions of hardware processors with software including digital signal processor(s), software, and memory(ies) that work together to cause an apparatus, such as a terminal device or a network device, to perform various functions. In a still further example, the circuitry may be hardware circuits and or processors, such as a microprocessor or a portion of a microprocessor, that requires software/firmware for operation, but the software may not be present when it is not needed for operation. As used herein, the term circuitry also covers an implementation of merely a hardware circuit or processor(s) or a portion of a hardware circuit or processor(s) and its (or their) accompanying software and/or firmware.

Generally, various embodiments of the present disclosure may be implemented in hardware or special purpose circuits, software, logic or any combination thereof. Some aspects may be implemented in hardware, while other aspects may be implemented in firmware or software which may be executed by a controller, microprocessor or other computing device. While various aspects of embodiments of the present disclosure are illustrated and described as block diagrams, flowcharts, or using some other pictorial representation, it will be appreciated that the blocks, apparatus, systems, techniques or methods described herein may be implemented in, as non-limiting examples, hardware, software, firmware, special purpose circuits or logic, general purpose hardware or controller or other computing devices, or some combination thereof.

The present disclosure also provides at least one computer program product tangibly stored on a non-transitory computer readable storage medium. The computer program product includes computer-executable instructions, such as those included in program modules, being executed in a device on a target real or virtual processor, to carry out the process or method as described above with reference to FIGS. 1A to 13. Generally, program modules include routines, programs, libraries, objects, classes, components, data structures, or the like that perform particular tasks or implement particular abstract data types. The functionality of the program modules may be combined or split between program modules as desired in various embodiments. Machine-executable instructions for program modules may be executed within a local or distributed device. In a distributed device, program modules may be located in both local and remote storage media.

Program code for carrying out methods of the present disclosure may be written in any combination of one or more programming languages. These program codes may be provided to a processor or controller of a general purpose computer, special purpose computer, or other programmable data processing apparatus, such that the program codes, when executed by the processor or controller, cause the functions/operations specified in the flowcharts and/or block diagrams to be implemented. The program code may execute entirely on a machine, partly on the machine, as a stand-alone software package, partly on the machine and partly on a remote machine or entirely on the remote machine or server.

The above program code may be embodied on a machine readable medium, which may be any tangible medium that may contain, or store a program for use by or in connection with an instruction execution system, apparatus, or device. The machine readable medium may be a machine readable signal medium or a machine readable storage medium. A machine readable medium may include but not limited to an electronic, magnetic, optical, electromagnetic, infrared, or semiconductor system, apparatus, or device, or any suitable combination of the foregoing. More specific examples of the machine readable storage medium would include an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing.

Further, while operations are depicted in a particular order, this should not be understood as requiring that such operations be performed in the particular order shown or in sequential order, or that all illustrated operations be performed, to achieve desirable results. In certain circumstances, multitasking and parallel processing may be advantageous. Likewise, while several specific implementation details are contained in the above discussions, these should not be construed as limitations on the scope of the present disclosure, but rather as descriptions of features that may be specific to particular embodiments. Certain features that are described in the context of separate embodiments may also be implemented in combination in a single embodiment. Conversely, various features that are described in the context of a single embodiment may also be implemented in multiple embodiments separately or in any suitable sub-combination.

Although the present disclosure has been described in language specific to structural features and/or methodological acts, it is to be understood that the present disclosure defined in the appended claims is not necessarily limited to the specific features or acts described above. Rather, the specific features and acts described above are disclosed as example forms of implementing the claims.

1-40. (canceled)

41. A method for terminal device, the method comprising:
receiving, from a first network device, a lower-layer signaling indicating a cell change or addition for a primary cell of a second network device, the lower-layer signaling comprising a first configuration for a contention free random access procedure for the primary cell; and
performing, at least based on the first configuration, a first random access procedure on the primary cell.

42. The method of claim 41, wherein the first network device and the second network device are same network device.

43. The method of claim 41, wherein performing the first random access procedure comprises:
determining a first random access parameter based on an indication of the first random access parameter in the first configuration; and
performing the first random access procedure based on the first random access parameter.

44. The method of claim 41, wherein performing the first random access procedure comprises:
determining a first random access parameter based on a predetermined value of the first random access parameter; and
performing the first random access procedure based on the first random access parameter.

45. The method of claim 42, wherein the first random access parameter comprises at least one of the following:
a carrier, a random access type, a reference signal, a preamble, or a random access occasion.

46. The method of claim 41, wherein the first configuration comprises at least one of the following:
a random access preamble index, a physical random access channel occasion parameter, an index of a reference signal, a supplementary or normal uplink indicator, or random access type information.

47. The method of claim 41, wherein the lower-layer signaling further comprises a second configuration for a contention free random access procedure for a secondary cell of the second network device.

48. The method of claim 47, further comprising:
determining a second random access parameter for the secondary cell based on an indication of the second random access parameter in the second configuration; and
performing a second random access procedure on the secondary cell based on the second random access parameter.

49. The method of claim 47, further comprising:
determining a second random access parameter based on a comparison between reference signal receive power of a downlink pathloss reference and threshold power; and
performing a second random access procedure based on the second random access parameter.

50. The method of claim 47, further comprising:
determining a second random access parameter based on a predetermined value of the first random access parameter; and
performing a second random access procedure based on the second random access parameter.

51. The method of claim 48, wherein performing the second random access procedure comprises:
transmitting a random access preamble on the secondary cell; and
receiving a random access response on the primary cell.

52. The method of claim 48, wherein the second random access parameter comprises at least one of the following:
a carrier, a random access type, a reference signal, a preamble, or a random access occasion.

53. The method of claim 47, wherein the second configuration comprises at least one of the following:
a random access preamble index, a physical random access channel occasion parameter, an index of a reference signal, a supplementary or normal uplink indicator, or random access type information.

54. The method of claim 41, further comprising:
transmitting, to the first network device, a random access report comprising a first indicator, the first indicator being used for indicating a random access scenario for which a random access report is triggered upon execution of a reconfiguration with sync; or
transmitting, to the first network device, a random access report comprising a second indicator dedicated to indicate that the first random access procedure is initiated in the primary cell by the lower-layer signaling.

55. The method of claim 48, further comprising:
transmitting, to the first network device, a random access report comprising a third indicator, the third indicator being used for indicating a random access scenario for which the random access report is triggered if a random access procedure is initiated in a primary cell by downlink or uplink data arrival during a connected state of the terminal device when a time alignment timer is not running in a primary timing advance group or if the random access procedure is initiated in a serving cell by a physical downlink control channel order; or
transmitting, to the first network device, a random access report comprising a fourth indicator to indicate that the second random access procedure is initiated in the secondary cell by a lower-layer signaling.

56. A method for a first network device, the method comprising:
determining a first configuration for a contention free random access procedure for a primary cell of a second network device; and
transmitting, to a terminal device, a lower-layer signaling indicating a cell change or addition for the primary cell and comprising the first configuration.

57. The method of claim 56, wherein determining the first configuration comprises:
determining a first random access parameter for a first random access procedure on the primary cell; and
generating the first configuration comprising an indication of the first random access parameter.

58. The method of claim 57, wherein the first random access parameter comprises at least one of the following:
a carrier, a random access type, a reference signal, a preamble, or a random access occasion.

59. The method of claim 56, wherein the first configuration comprises at least one of the following:
a random access preamble index, a physical random access channel occasion parameter, an index of a reference signal, a supplementary or normal uplink indicator, or random access type information.

60. A terminal device comprising:
at least one memory; and
at least one processor operatively connected to the at least one memory,
wherein the at least one processor is configured to:
receive, from a first network device, a lower-layer signaling indicating a cell change or addition for a primary cell of a second network device, wherein the lower-layer signaling comprises a first configuration for a contention free random access procedure for the primary cell, and
perform, at least based on the first configuration, a first random access procedure on the primary cell.

61. A first network device comprising:
at least one memory; and
at least one processor operatively connected to the at least one memory,
wherein the at least one processor is configured to:
determine a first configuration for a contention free random access procedure for a primary cell of a second network device, and
transmit, to a terminal device, a lower-layer signaling indicating a cell change or addition for the primary cell, wherein the lower-layer signaling comprises the first configuration.
